(19) United States
(12) Patent Application Publication
(10) Pub. No.: US 2002/0166051 A1
(43) Pub. Date: Nov. 7, 2002

(54) Method, system, and apparatus for encrypting a web browser script

(76) Inventor: Marvin Moser, Chicago, IL (US)

Correspondence Address: MORGAN & FINNEGAN, L.L.P., 345 Park Avenue, New York, NY, 10154, US

(21) Appl. No.: 09/847,709

(22) Filed: May 3, 2001

(51) Int. Cl. H04K 1/00

(52) U.S. Cl. 713/182

(57) ABSTRACT

A method, system, and apparatus for encrypting a web browser script that prevents an unauthorized user from inspecting or reverse engineering the script and is compatible with any script-enabled web browser. When development of a script is complete, a script author uses an encryption program to encrypt the script, modify the web page to refer to the encrypted script, and create a decryption program capable of decrypting the encrypted script. The system makes the encrypted script publicly available on the Internet by copying the encrypted script, modified web page, and decryption program to a web server. A user accessing the encrypted script uses a web browser on the client computer to request from a web server a web page that includes a reference to the encrypted script. The web browser displays the contents of the web page to the user by interpreting the hypertext markup language (“HTML”) tags embedded in the web page. The HTML tags embedded in the web page identify the uniform resource locators (“URLs”) for the decryption program and encrypted script. The runtime environment of the client computer receives the decryption program and encrypted script from the web server and applies the decryption program to the encrypted script to produce the script. The runtime environment transfers the script to the web browser for execution.

### FIELD OF THE INVENTION

A method, system, and apparatus for encrypting a web browser script. In particular, a method, system, and apparatus for encrypting a web browser script to prevent an unauthorized user from inspecting or reverse engineering the script.

### BACKGROUND OF THE INVENTION

The expansion of the Internet has fueled a significant increase in the number of proprietary web browser scripts accessed by public web pages. Unfortunately, anyone can use a web browser to examine and reverse engineer a script that is publicly available on the Internet by simply visiting the web site that hosts the script. Computer authentication, authorization, and encryption techniques are the only mechanisms available to restrict access to the script.

The first step to secure a web server involves using traditional computer authentication and authorization techniques. These techniques grant or deny a user access to the system by authenticating a user's claimed identity and authorizing the capabilities available to an authenticated user. For example, a system may authorize an anonymous user to read the contents of the main web page, but not to have the ability to shut down the computer or alter the system accounting files. A web site designer uses these traditional techniques to prevent an authorized user from breaking into and gaining control of the web site. The second step to secure a web server involves using encryption techniques to secure the information communicated over the Internet. The two types of encryption algorithms in common use today are symmetric key algorithms and public key algorithms. Symmetric key algorithms are used for the bulk encryption of data or data streams and are designed to be very fast and usually have a large number of possible keys. Symmetric key algorithms commonly encountered in the field of web security include the Data Encryption Standard (“DES”), Triple-DES, and International Data Encryption Algorithm (“IDEA”). Public key algorithms encrypt information with one key and decrypt the information with an apparently unrelated, second key. Public key algorithms commonly encountered in the field of web security include Diffie-Hellman key exchange, RSA (“Ronald Rivest, Adi Shamir, and Leonard Adleman”), ElGamel, and Digital Signature Standard (“DSS”).

The user sets privacy restrictions for a web browser on the client computer. An author of a script must, therefore, petition and convince the user to lower the privacy restrictions for the author's script. Technically, the author achieves this goal by “signing” the script and by embedding it in a web page that the user views with a web browser. Unfortunately, the current web browser vendors have developed different and incompatible encryption and hypertext markup language (“HTML”) techniques for handling a signed script, but the systems are based on the same concepts of computer encryption and cryptography. Thus, to prevent access to a script in the current Internet web browser environment, a company must maintain a version of the encrypted script for each vendor's web browser.

In view of this deficiency, there is a need for a method, system, and apparatus for encrypting a web browser script that will prevent an unauthorized user from inspecting or reverse engineering the web browser script and will work with any script-enabled web browser. A system that meets this need reduces script maintenance costs for the script owner and eliminates the effort and cost of obtaining security certificates. The method, system, and apparatus for encrypting a web browser script disclosed herein address this need.

### SUMMARY OF THE INVENTION

A method, system, and apparatus for encrypting a web browser script that will prevent an unauthorized user from inspecting or reverse engineering the script and is compatible with any script-enabled web browser.

The system includes a script, a web page that refers to the script, and an encryption program capable of transforming the script into an encrypted script. In one embodiment, when development of the script is complete, a script author executes the encryption program to transform the script into the encrypted script, modify the web page to refer to the encrypted script, and create a decryption program capable of transforming the encrypted script into the script. Another embodiment automates this process and does not require the script author to take any action because the system integrates the encryption program with the development environment. The system grants access to the encrypted script by copying the encrypted script, modified web page, and decryption program to a web server.

A user accesses the encrypted script by using a web browser on the client computer to issue a first request for the modified web page. The web server receives the first request and retrieves the modified web page for the web browser. The web browser displays the contents of the modified web page to the user by interpreting the hypertext markup language (“HTML”) that comprises the modified web page. An HTML tag embedded in the modified web page includes a reference to the decryption program that will decrypt the encrypted script. The web browser issues a second request for the decryption program. The web server receives the second request and retrieves the decryption program for the web browser. The HTML tag for the decryption program embedded in the modified web page also includes a reference to the encrypted script. The web browser invokes the decryption program with the reference to the encrypted script to cause the runtime environment on the client computer to load the decryption program and issue a third request for the encrypted script. The web server receives the third request and retrieves the encrypted script for the runtime environment. The runtime environment executes the decryption program to decrypt the encrypted script and produce the script. The runtime environment transfers the script to the web browser for execution.

In another embodiment, the user accesses the encrypted script by using a multi-tasking web browser on the client computer to issue a first request for the modified web page. The web server receives the first request and retrieves the modified web page for the multi-tasking web browser. The multi-tasking web browser displays the contents of the modified web page to the user by interpreting the HTML that comprises the modified web page. An HTML tag embedded in the modified web page includes a reference to the decryption program capable of decrypting the encrypted script. Recognition of the reference to the decryption program causes the multi-tasking web browser to concurrently launch a first and a second task. The first concurrent task issues a second request for the decryption program. The web server receives the second request and retrieves the decryption program for the multi-tasking web browser. Another HTML tag embedded in the modified web page includes a reference to the encrypted script. The multi-tasking tasking web browser invokes the decryption program with the reference to the encrypted script to cause the multi-tasking runtime environment to suspend until the encrypted script is available. The second concurrent task issues a third request for the encrypted script. The web server receives the third request and retrieves the encrypted script for the multi-tasking web browser. The multi-tasking web browser receives and stores the encrypted script to signal the multi-tasking runtime environment that the encrypted script is available. This signal is the synchronization mechanism for the first and the second task. The multi-tasking runtime environment executes the decryption program to decrypt the encrypted script and produce the script. The multi-tasking runtime environment transfers the script to the multi-tasking web browser for execution.

### BRIEF DESCRIPTION OF THE DRAWINGS

The accompanying figures best illustrate the details of the script encryption system, both as to its structure and operation. Like reference numbers and designations in these figures refer to like elements.

FIG. 1 is a network diagram depicting an embodiment of an operating environment for the script encryption system disclosed herein.

FIG. 2 is a flow diagram of an embodiment of a process that stores an encrypted script on a web server.

FIG. 3A is a flow diagram of an embodiment of a process for loading and executing a decryption program and an encrypted script on a web browser.

FIG. 3B is a flow diagram of an embodiment of the process disclosed in FIG. 3A that uses concurrent task execution.

### DETAILED DESCRIPTION OF THE INVENTION

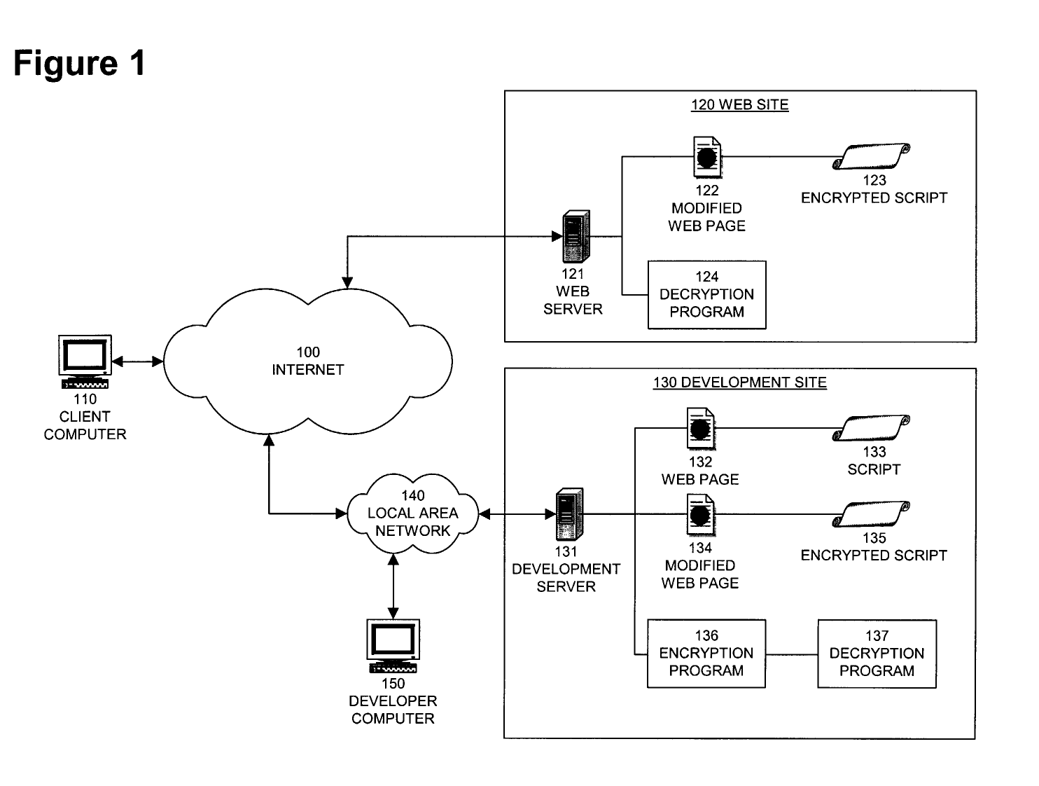

FIG. 1 depicts an operating environment for an embodiment of the script encryption system disclosed herein. Internet 100, a public communication network, is the communication medium that enables client computer 110 to communicate with web site 120. Optionally, client computer 110 may also use Internet 100 to communicate via local area network 140 with either development site 130 or developer computer 150.

Even though the embodiment depicted in FIG. 1 uses a public communication network, the script encryption system contemplates the use of public or private network architectures such as an intranet or extranet. An intranet is a private communication network that functions similar to Internet 100. An organization such as a corporation creates an intranet to provide a secure means for members of the organization to access the resources on the organization's network. An extranet is also a private communication network that functions similar to Internet 100. In contrast to an intranet, an extranet provides a secure means for the organization to authorize non-members of the organization to access certain resources on the organization's network. The script encryption system also contemplates using a network protocol such as Ethernet or Token Ring as well as proprietary network protocols.

Development site 130 includes development server 131, a general-purpose network server that includes a web server (not shown) and is accessible via local area network 140 by a developer using developer computer 150. In another embodiment, a dedicated link connecting development server 131 and developer computer 150 replaces local area network 140. In yet another embodiment, development server 131 and developer computer 150 are the same computer. Yet another embodiment eliminates not only local area network 140, but also the connection to Internet 100.

A developer uses an editing program resident on developer computer 150 to create, edit, and store web page 132 and script 133 on development site 130. Web page 132 is based on the hypertext markup language (“HTML”) standard, includes a reference to script 133, and is accessible via development server 131.

Encryption program 136 is a computer program that applies an encryption algorithm and encryption key to an input object to produce an encrypted object that conceals the contents of an input object. In addition, encryption program 136 produces decryption program 137, a computer program that reverses the encryption algorithm applied by encryption program 136 by processing the encrypted object to produce the input object. A programming language such as “C”, “C++”, or Java is sufficient for the encryption program 136 or decryption program 137. Also, the script encryption system contemplates using symmetric as well as public key encryption algorithms.

When the development of web page 132 and script 133 is complete, the developer applies encryption program 136 to script 133 and stores the result, encrypted script 135, in a location that is accessible by development server 131. The developer then edits web page 132 by modifying each reference to script 133 to refer instead to encrypted script 135 and stores the result, modified web page 134, in a location that is accessible by development server 131. In another embodiment, development site 130 automatically creates encrypted script 135 and modified web page 134 when the developer stores script 133 on development site 130.

When this transformation is complete and fully tested, the developer copies modified web page 134 to web site 120 as modified web page 122, encrypted script 135 to web site 120 as encrypted script 123, and decryption program 137 to web site 120 as decryption program 124. The script encryption system copies modified web page 134, encrypted script 135, and decryption program 137 using any acceptable protocol such as file transfer protocol, simple mail transfer protocol, or file copy and any communication medium such as Internet 100, intranet, or floppy disk. Modified web page 122, encrypted script 123, and decryption program 124 are each accessible via web server 121.

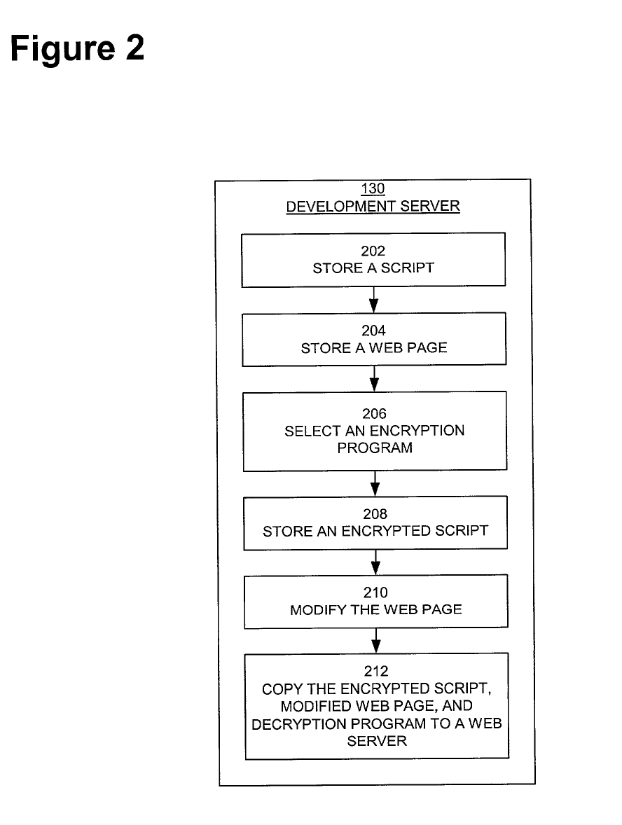

FIG. 2 is a flow diagram of an embodiment of a method that the script encryption system performs to store modified web page 122, encrypted script 123, and decryption program 124 on web server 121. At step 202, a developer stores script 133 in a location that is accessible by development server 131. Similarly, at step 204, the developer stores web page 132 in a location that is accessible by development server 131. At step 206, the developer selects an encryption program 136. At step 208, the developer performs encryption program 136 to encrypt script 133 and store the results, encrypted script 135 and decryption program 137, in a location that is accessible by development server 131. At step 210, the developer modifies web page 132 and stores the result, modified web page 134, in a location that is accessible by development server 131. The modifications include adding a reference to decryption program 137 and changing each reference to script 133 to refer to encrypted script 135. At step 212, the developer copies modified web page 134, encrypted script 135, and decryption program 137 to web server 121, respectively, as modified web page 122, encrypted script 123, and decryption program 124.

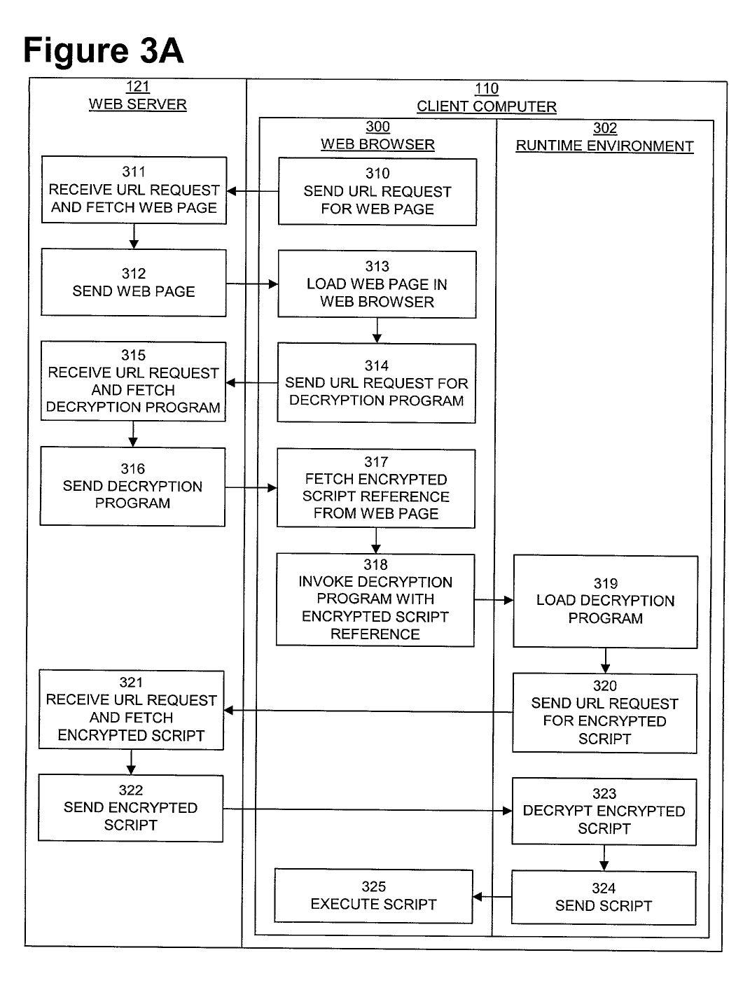

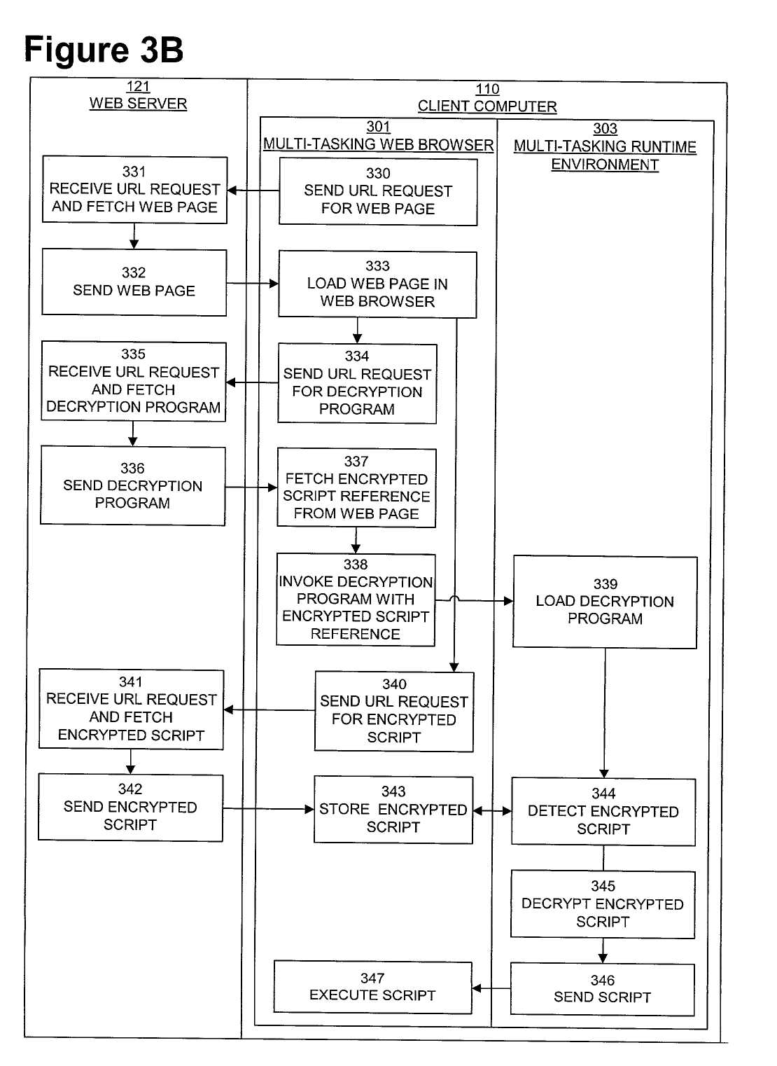

FIG. 3A is a flow diagram of an embodiment of a method that the script encryption system performs to load and execute decryption program 124, modified web page 122, and encrypted script 123 from client computer 110. FIG. 3A depicts the flow of control between web server 121, web browser 300 running on client computer 110, and runtime environment 302 running on client computer 110. A user working on client computer 110 begins the process, at step 310, by using web browser 300 to send a uniform resource locator (“URL”) request for modified web page 122 to web server 121. Web server 121 receives the URL request and retrieves modified web page 122 at step 311, and sends modified web page 122 to web browser 300 at step 312. At step 313, web browser 300 loads modified web page 122 into web browser 300. During the loading process, web browser 300 will detect that modified web page 122 includes a URL reference to decryption program 124 and, at step 314, send a URL request for decryption program 124 to web server 121. Web server 121 receives the URL request and retrieves decryption program 124 at step 315, and sends decryption program 124 to web browser 300 at step 316. At step 317, web browser 300 retrieves a reference to encrypted script 123 from modified web page 122 and, at step 318, invokes decryption program 124 with the reference to encrypted script 123. At step 319, runtime environment 302 loads decryption program 124 and, at step 320, sends a URL request for encrypted script 123 to web server 121. Web server 121 receives the URL request and retrieves encrypted script 123 at step 321, and sends encrypted script 123 to runtime environment 302 at step 322. At step 323, runtime environment 302 decrypts encrypted script 123 to produce script 133 and, at step 324, sends script 133 to web browser 300. At step 325, web browser 300 executes script 133.

FIG. 3B is a flow diagram of another embodiment of the method disclosed in FIG. 3A that takes advantage of concurrent task execution. The script encryption system performs the method disclosed in FIG. 3B to load and execute decryption program 124, modified web page 122, and encrypted script 123 from client computer 110. FIG. 3B depicts the flow of control between web server 121, multi-tasking web browser 301 running on client computer 110, and multi-tasking runtime environment 303 running on client computer 110. A user working on client computer 110 begins the process, at step 330, by using multi-tasking web browser 301 to send a URL request for modified web page 122 to web server 121. Web server 121 receives the URL request and retrieves modified web page 122 at step 331, and sends modified web page 122 to multi-tasking web browser 301 at step 332. At step 333, multi-tasking web browser 301 loads modified web page 122 into multi-tasking web browser 301. During the loading process, multi-tasking web browser 301 will detect that modified web page 122 includes a URL reference to decryption program 124 and launch two tasks for concurrent execution at steps 334 and 340. At step 334, multi-tasking web browser 301 launches a first concurrent task by sending a URL request for decryption program 124 to web server 121. Web server 121 receives the URL request and retrieves decryption program 124 at step 335, and sends decryption program 124 to multi-tasking web browser 301 at step 336. At step 337, multi-tasking web browser 301 retrieves a reference to encrypted script 123 from modified web page 122 and, at step 338, invokes decryption program 124 with the reference to encrypted script 123. At step 339, multi-tasking runtime environment 303 suspends to wait for multi-tasking runtime environment 303 to detect, at step 344, that multi-tasking web browser 301 stored encrypted script 123 at step 343. At step 340, multi-tasking web browser 301 launches a second concurrent task by sending a URL request for encrypted script 123 to web server 121. Web server 121 receives the URL request and retrieves encrypted script 123 at step 341, and sends encrypted script 123 to multi-tasking web browser 301 at step 342. At step 343, multi-tasking web browser 301 stores encrypted script 123 and triggers multi-tasking runtime environment 303 to synchronize the first and the second concurrent task by detecting, at step 344, the availability of encrypted script 123. At step 345, multi-tasking runtime environment 303 decrypts encrypted script 123 to produce script 133 and, at step 346, sends script 133 to multi-tasking web browser 301. At step 347, multi-tasking web browser 301 executes script 133.

Although the embodiments disclosed herein describe a fully functioning method, system, and apparatus for encrypting a web browser script system, the reader should understand that other equivalent embodiments exist. Since numerous modifications and variations will occur to those who review this disclosure, the script encryption system is not limited to the exact construction and operation illustrated and described herein. Accordingly, this disclosure intends all suitable modifications and equivalents to fall within the scope of the claims.

I claim:

1. A method that restricts access to a script comprising the steps of:
storing an encrypted script;
storing a hypertext object including a reference to the encrypted script; and
storing a decryption program capable of decrypting the encrypted script, the hypertext object including a reference to the decryption program,
whereby access to the hypertext object only allows access to the encrypted script.

2. The method of claim 1, wherein the hypertext object and the encrypted script are stored on a server.

3. The method of claim 1, wherein the hypertext object and the encrypted script are stored as a single downloadable object.

4. The method of claim 1, wherein the decryption program is stored on a server.

5. The method of claim 1, wherein the encrypted script and the decryption program are stored as a single downloadable object.

6. The method of claim 1, wherein the hypertext object, the encrypted script, and the decryption program are stored as a single downloadable object.

7. The method of claim 1, wherein storing an encrypted script further comprises the steps of:
selecting an encryption algorithm;
selecting an encryption key; and
creating the encrypted script by executing the encryption algorithm and applying the encryption key.

8. The method of claim 7, wherein the encryption algorithm is a symmetric encryption algorithm.

9. The method of claim 7, wherein the encryption algorithm is a public key encryption algorithm.

10. A method that restricts access to a script comprising the steps of:
storing an encrypted script that conceals and restricts access to the script;
storing a hypertext object including a reference to the encrypted script; and
storing a decryption program capable of decrypting the encrypted script, the hypertext object including a reference to the decryption program,
whereby access to the hypertext object only allows access to the encrypted script.

11. The method of claim 10, wherein the hypertext object and the encrypted script are stored on a server.

12. The method of claim 10, wherein the hypertext object and the encrypted script are stored as a single downloadable object.

13. The method of claim 10, wherein the decryption program is stored on a server.

14. The method of claim 10, wherein the encrypted script and the decryption program are stored as a single downloadable object.

15. The method of claim 10, wherein the hypertext object, the encrypted script and the decryption program are stored as a single downloadable object.

16. The method of claim 10, wherein storing an encrypted script further comprises the steps of:
selecting an encryption algorithm;
selecting an encryption key; and
transforming the script into the encrypted script by executing the encryption algorithm and applying the encryption key.

17. The method of claim 16, wherein the encryption algorithm is a symmetric encryption algorithm.

18. The method of claim 16, wherein the encryption algorithm is a public key encryption algorithm.

19. A method that restricts access to a script comprising the steps of:
storing an encrypted script that conceals and restricts access to the script;
storing a hypertext object that modifies a reference to the script to refer to the encrypted script; and
storing a decryption program capable of decrypting the encrypted script, the hypertext object, the reference to the script further modified to include a reference to the decryption program.

20. The method of claim 19, wherein the hypertext object and the encrypted script are stored on a server.

21. The method of claim 19, wherein the hypertext object and the encrypted script are stored as a single downloadable object.

22. The method of claim 19, wherein the decryption program is stored on a server.

23. The method of claim 19, wherein the encrypted script and the decryption program are stored as a single downloadable object.

24. The method of claim 19, wherein the hypertext object, the encrypted script, and the decryption program are stored as a single downloadable object.

25. The method of claim 19, wherein storing an encrypted script further comprises the steps of:
selecting an encryption algorithm;
selecting an encryption key; and
transforming the script into the encrypted script by executing the encryption algorithm and applying the encryption key.

26. The method of claim 25, wherein the encryption algorithm is a symmetric encryption algorithm.

27. The method of claim 25, wherein the encryption algorithm is a public key encryption algorithm.

28. A method that restricts access to a script comprising the steps of:
receiving a request for a hypertext object including a reference to an encrypted script and a reference to a decryption program capable of decrypting the encrypted script;
transferring the hypertext object; and
transferring the encrypted script.

29. The method of claim 28, further comprising the step of:
receiving a request for the encrypted script.

30. The method of claim 29, wherein the request for the encrypted script is prompted by receipt of the hypertext object.

31. The method of claim 28, further comprising the step of:
issuing a request for the encrypted script.

32. The method of claim 31, wherein the request for the encrypted script is prompted by receipt of the hypertext object.

33. The method of claim 28, further comprising the step of:
transferring the decryption program.

34. The method of claim 33, further comprising the step of:
receiving a request for the decryption program.

35. The method of claim 34, wherein the request for the decryption program is prompted by receipt of the hypertext object.

36. The method of claim 33, further comprising the step of:
issuing a request for the decryption program.

37. The method of claim 36, wherein the request for the decryption program is prompted by receipt of the hypertext object.

38. A method that restricts access to a script comprising the steps of:
issuing a request for a hypertext object including a reference to an encrypted script and a reference to a decryption program capable of decrypting the encrypted script;
receiving the hypertext object; and
receiving the encrypted script.

39. The method of claim 38, further comprising the steps of:
decrypting the encrypted script; and
presenting the hypertext object on a display device.

40. The method of claim 38, further comprising the step of:
issuing a request for the encrypted script.

41. The method of claim 40, wherein the request for the encrypted script is prompted by receipt of the hypertext object.

42. The method of claim 38, further comprising the step of:
receiving a request for the encrypted script.

43. The method of claim 42, wherein the request for the encrypted script is prompted by receipt of the hypertext object.

44. The method of claim 38, further comprising the steps of:
issuing a request for a decryption program; and
receiving the decryption program.

45. The method of claim 44, wherein the request for the decryption program is prompted by receipt of the hypertext object.

46. The method of claim 38, further comprising the steps of:
receiving a request for a decryption program; and
receiving the decryption program.

47. The method of claim 46, wherein the request for the decryption program is prompted by receipt of the hypertext object.

48. A system that restricts access to a script comprising:
an encrypted script;
a hypertext object including a reference to the encrypted script; and
a decryption program capable of decrypting the encrypted script, the hypertext object including a reference to the decryption program.

49. The system of claim 48, further comprising:
an encryption key; and
an encryption program capable of encryption the script by applying the encryption key.

50. The system of claim 49, wherein the encryption program implements a symmetric encryption algorithm.

51. The system of claim 49, wherein the encryption program implements a public key encryption algorithm.

52. A system that restricts access to a script comprising:
an encrypted script that conceals and restricts access to the script;
a hypertext object that modifies a reference to the script to refer to the encrypted script; and
a decryption program capable of decrypting the encrypted script, the hypertext object including a reference to the decryption program.

53. The system of claim 52, further comprising:
an encryption key; and
an encryption program capable of encrypting the script by applying the encryption key.

54. The system of claim 53, wherein the encryption program implements a symmetric encryption algorithm.

55. The system of claim 53, wherein the encryption program implements a public key encryption algorithm.
